(19) United States
(12) Patent Application Publication
(10) Pub. No.: US 2006/0279061 A1
(43) Pub. Date: Dec. 14, 2006

(54) Fork Leg Cap

(76) Inventor: Christopher Hill, Huntington Beach, CT (US)

Correspondence Address: MARIO G. CESTE, 4 TURNBERRY ROAD, SUITE 100, WALLINGFORD, CT, 06492, US

(21) Appl. No.: 11/160,208

(22) Filed: Jun. 14, 2005

(51) Int. Cl. B62K 21/00

(52) U.S. Cl. 280/279

(57) ABSTRACT

A fork leg cap for the attachment of a wheel to a fork assembly so when the wheel is attached to the fork leg, the mounting studs and nuts holding the fork leg cap in place against the fork leg end are hidden from view making the fork leg appear as a continuous solid piece. Particularly this invention relates to the attachment of the front wheel of a motorcycle and allows all the parts showing on the fork assembly to be chrome since the mounting hardware which secures the front wheel to the fork leg are hidden making the end of each fork appear to be continuous piece.

### FIELD OF INVENTION

This invention relates to an assembly and apparatus for securing a wheel to a vehicle and more particularly to the securing of the front wheel of a motorcycle to the fork of the motorcycle.

### DESCRIPTION OF PRIOR ART

The motorcycle is a two-wheel vehicle consisting of a front and rear wheel. There are also models referred to as “trikes”. Trikes have left and right rear wheels connected by an axle in the same manner as an automobile. However all motorcycles have a single front wheel which is attached to the frame of the motorcycle by a fork assembly.

The fork assembly is connected to a set of handle bars. The handle bars and fork attach to the motorcycle frame and can swivel providing a method for steering the motorcycle. By rotating the movement of the handle bars either left or right the front wheel of the motorcycle is steered in the direction which the handle bars were moved.

The fork assembly of the motorcycle splits below the frame into two parallel members called the fork legs. There is a left and a right leg which allow for the attachment of the front wheel. The front wheel of a motorcycle is typically mounted on a rotating axle or spindle which spans the lower ends of the two parallel legs of the front fork. The lower end of the fork leg is the end opposite the handbars, where the two fork legs are joined. The end of each fork leg where the front wheel mounts incorporates a removable piece called a fork leg cap. The fork leg cap captures the axle against the end of the fork leg. The fork leg cap is secured to the fork leg by studs and nuts. There is one fork leg cap for each fork leg, that is a fork leg cap for the left and right fork leg. Many times the left and right fork leg cap, while mechanically identical, are slightly different in appearance. This results in each fork leg, left and right, appearing slightly different after the wheel is attached.

When the fork leg cap is attached to the end of the fork leg, it creates a closed cylinder for capturing the front wheel axle or spindle. One half of the cylinder is formed in the lower end of the fork leg while the other half of the cylinder is formed in the fork leg cap. When the fork leg cap is secured to the fork leg the mounting hardware, namely studs and nuts, are visible after the front wheel is attached in place.

These motorcycles are often the pride of their owners who want to achieve a personalized and unique distinctive look for their motorcycle. The most common way for a motorcycle owner to achieve the distinctive look for their motorcycle is by customizing it. Therefore, original equipment manufacturers as well as generic component fabricators offer large assortments of custom parts and accessories for customizing these motorcycles to satisfy a great number of different preferences.

A common custom modification performed by motorcycle owners is to chrome plate many of the parts on their motorcycle. The parts which are chromed include wheels, exhausts, carburetors, mirrors, gauges, gas tanks, transmissions, engine blocks and numerous other parts of the motorcycle not listed here. In particular, chrome plating of the front wheels and the fork assembly has become one of the more popular modifications.

However while chrome plating the fork assembly enhances the appearance of the front of the motorcycle, the current way the front wheel is secured to the fork leg has left exposed hardware that is not chrome. It has also prevented the motorcycle owner from achieving a uniform chrome appearance for the fork leg. FIG. 1 shows the prior art fork leg assembly with the fork leg cap attached to the fork leg. The front wheel of the motorcycle has been omitted for ease of viewing the fork leg cap and fork leg. As can be seen from FIG. 1 when the fork leg cap is assembled to the fork leg, again omitting the front wheel here for ease of viewing, the mounting hardware, namely the bolts and nuts, remain showing. The only alternative available has been to completely replace the original fork leg assembly with a new and different one at great cost and difficulty so that a uniform chrome appearance was obtained and no exposed mounting hardware remained.

These motorcycle owners and also owners of other vehicles with similar methods for securing a wheel have been in need of an improved way to attach the wheel to their vehicle which has the mounting hardware hidden, which can be completely chrome plated, and which would not require them to replace the complete original fork assembly to achieve this result.

### DESCRIPTION OF DRAWINGS

FIG. 1 shows the prior art fork leg assembly with the fork leg cap attached to the fork leg.

FIG. 2 is a view of the improved fork leg cap looking at the lower surface.

FIG. 3 is a view of the improved fork leg cap looking at the upper surface.

FIG. 4 is a side view of the improved fork leg cap.

FIG. 5 is a cross-section view of FIG. 4 of the improved fork leg cap.

FIG. 6 is a view of the improved fork leg assembly with the improved fork leg cap attached to the fork leg.

### DETAILED DESCRIPTION OF THE INVENTION

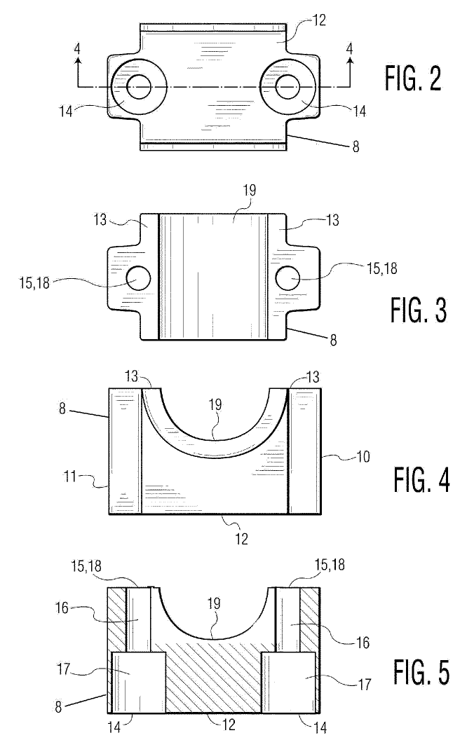

The new and improved fork leg cap (8), referring to FIGS. 2 thru 6, overcomes the problem of having to replace the original equipment fork assembly if a completely chrome fork assembly is desired. It provides a method to conceal the mounting hardware which holds the front wheel in place on the fork leg of the motorcycle. Since the invention does not require the replacement of the original fork assembly, the existing original two fork legs which straddle the front wheel are not modified and are used as supplied. This results in an improvement which is less costly over the prior art because the original equipment fork legs do not have to be replaced or modified.

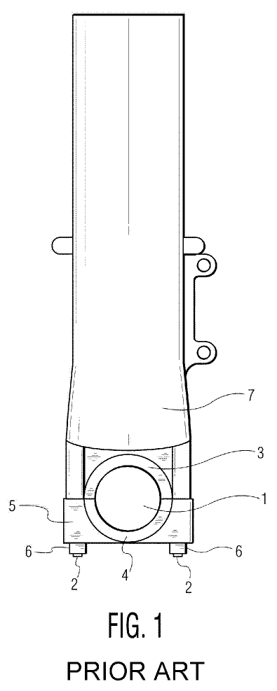

Referring to FIG. 1, showing the prior art, for each fork leg (7) the front wheel is attached by the respective ends of its axle being captured in a circular opening (1) in the end of the fork leg. The lower end of the fork leg is shaped in the form of a half circle (3), which becomes the upper half of the circular opening (1). While the fork leg cap (5) when attached to the fork leg (7) forms the lower half of the circular opening.

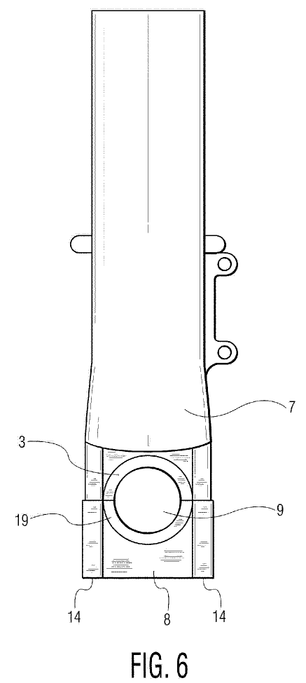

In FIG. 1, the mounting hardware, namely bolts (2) and nuts (6) are visible after the fork leg cap (5) is attached to the fork leg. Now referring to FIG. 6, which is the new and improved assembly, each fork leg (7) is identical to the fork leg in the previous illustration (FIG. 1). However referring once again to FIG. 6, while the new and improved fork leg cap mounts to the fork leg engaging with the existing fork leg studs (shown previously in FIG. 1 as item 2) the mounting hardware is no longer visible. Still referring to FIG. 6, the new and improved fork leg cap is also secured to the fork leg with nuts forming an identical circular opening (9) in the end of the fork leg (7) for securing the front axle in a manner identical to the original equipment fork leg cap.

The new and improved fork leg cap, referring to FIG. 4, has an upper surface (13) and lower surface (12). The upper surface contains a semi-circular opening which is in the shape of a half-circle (19). This semi-circular opening mates with a corresponding semi-circular opening (FIG. 6 item 3) and receives the front wheel axle and captures it against the lower end of the fork leg. When the fork leg cap is attached to the fork leg a circular opening (9) is formed allowing the wheel axle to be captured.

The new and improved fork leg cap (8), referring to FIG. 3 and FIG. 5 for various views, has two holes (18)(15), one on either end of its half-circle for receiving the two studs from the fork leg. The two holes (14), referring to in FIG. 2 and FIG. 5, are parallel to the left and right sides of the fork leg cap, and are bored the complete length of the respective left and right side of the fork leg cap. The holes each have two openings, one opening on the upper surface (13) of the fork leg cap and a second opening on the lower end of the fork leg cap (12). Each hole (15)(18), now referring to FIG. 5, has a smaller diameter at the first end of the hole (15) and a larger diameter at the opposite end (14).

Still referring to FIG. 5, the smaller diameter (16) of each hole starts at the upper end of the fork leg cap. The diameter is slightly greater than the diameter of the mounting stud (2) which protrudes downward from the fork leg end. The smaller diameter transitions to a larger diameter at a point approximately one-half the length of the respective left and right sides of the fork leg cap. The large diameter (17) continues until the lower end of the fork leg cap is reached (14). The depth of the larger diameter hole spans from the lower end of the fork leg cap to the transition point of the smaller diameter hole which is approximately one-half the distance of the length of the left and right sides.

The improved fork leg cap is attached to the lower end of the fork leg by being placed over the mounting studs (2) on the fork leg, then the mounting nuts (6) are threaded onto each of the studs and tightened securing the fork end cap in place against the lower end of the fork leg. One mounting nut is threaded onto each of the two studs which protrude from the fork leg.

Referring to FIG. 6, the studs and mounting nuts are concealed bores (14) of the body of the new and improved fork leg cap (8). The larger diameter hole (14) is large enough to receive the nut (6) when it is threaded onto the stud. The minimum depth of the larger diameter hole is such that it will conceal the nut when the fork leg cap is attached to the fork leg assembly. FIG. 5 shows a cross-section of the fork leg cap and illustrates the first diameter (16) and second diameter (17) of the bore (14)(15)(18).

The improved fork leg cap for both left and right fork legs are identical. This provides a uniform appearance for the two fork legs overcoming the limitations in the prior art where the left and right legs vary in appearance once the prior art caps are attached.

While the above description provides a full and complete disclosure of the preferred embodiment of this invention for use on a Harley Davidson motorcycle model FLT, FXST or FXDWG, various modifications, alternate constructions and equivalents may be employed without departing from the true spirit and scope of the invention to accommodate a greater variety of models of motorcycles. Such changes might involve alternate components, structural arrangements, or the application of the invention to motorcycles other than the specific model described herein. It could include the use of the invention on vehicles other than just motorcycles. Therefore the above description and accompanying illustrations should not be construed as limiting the scope of the invention which is defined by the appended claims.

What is claimed is:

1. A fork leg cap for attaching a vehicle wheel to a fork using nuts secured to studs which protrude from said fork wherein the improvement is said fork leg cap comprising:
An upper surface containing an opening for receiving the wheel and having two bores of a first diameter located at either end of said opening for receiving said studs;
A lower surface having said bores of a second diameter for receiving said studs and said nuts;
Said bores extending from said upper surface to said lower surface where said studs and said nuts are concealed within said second diameter when said fork leg cap is attached to said fork leg.

2. The improved fork leg cap of claim 1 where the vehicle is a motorcycle.

3. The improved fork leg cap of claim 1 where said fork leg cap is integrally formed.

4. The improved fork leg cap of claim 1 where said opening is a semi-circular arc.

5. The improved fork leg of claim 1 where said first diameter and said second diameter are concentric.

6. The improved fork leg of claim 1 where said second diameter is larger diameter than said first diameter.

7. The improved fork leg of claim 1 where said second diameter has a minimum depth necessary to conceal said studs and said nuts.

8. The improved fork leg of claim 1 where said fork leg cap is constructed from 7075 aluminum cnc.

9. An assembly for attaching a wheel using a fork leg with studs, a fork leg cap, and nuts comprising:
An upper and lower surface on said fork leg cap, with an opening for receiving the wheel on said upper surface;
Said upper surface contacting the lower end of said fork leg where said studs protrude;
Said nuts attaching to said studs;
A bore located at either end of said opening and extending from said upper surface to said lower surface for receiving said studs and having a diameter at said lower surface to receive said nuts, concealing said studs and said nuts when said fork leg cap is secured to said fork leg.

10. The assembly of claim 9 where said bore is concentric holes of two different diameters with the smaller diameter at said upper surface, and the larger diameter extending deep enough from said lower surface towards said upper surface to conceal the studs and nuts.

11. The assembly of claim 9 where said fork leg cap is integrally formed.
